(19) United States
(12) Patent Application Publication
(10) Pub. No.: US 2025/0250392 A1
(43) Pub. Date: Aug. 7, 2025

(54) ALKYL SUBSTITUTED AMINOPOLYMERS

(71) Applicant: Lawrence Livermore National Security, LLC, Livermore, CA (US)

(72) Inventors: Simon Hoching Pang, San Leandro, CA (US); Anthony John Varni, Dublin, CA (US); Eric Aidan Krall, Walnut Creek, CA (US)

(21) Appl. No.: 18/435,887

(22) Filed: Feb. 7, 2024

(51) Int. Cl. C08G 73/02

(52) U.S. Cl. CPC C08G 73/0233

(57) ABSTRACT

In one general embodiment, a product includes an aminopolymer having alkyl substituents coupled directly to carbon atoms in a backbone of the aminopolymer. In another general embodiment, a method of forming an alkyl substituted aminopolymer includes polymerizing, via ring-opening polymerization, one or more types of heterocyclic monomers thereby creating a first polymer, the one or more types of heterocyclic monomers having at least one alkyl substituent coupled directly to a carbon atom of the associated monomer; and creating, from the first polymer, an alkyl substituted aminopolymer.

This invention was made with Government support under Contract No. DE-AC52-07NA27344 awarded by the United States Department of Energy. The Government has certain rights in the invention.

### FIELD OF THE INVENTION

The present invention relates to aminopolymers, and more particularly, this invention relates to alkyl substituted aminopolymers, and methods of making the same.

### BACKGROUND

Solid-supported amine sorbents are a promising class of technology for CO₂ capture. The active material in these sorbents is an amine-dense polymer (aminopolymer), which is impregnated into a highly porous support to increase the aminopolymer's surface area. As illustrated in the schematic drawing in FIG. 1, gas mixtures having ultra-dilute concentrations of CO₂ may flow over a CO₂ chemisorbent, comprising a solid-supported aminopolymer, to which the CO₂ molecules bind.

While this technology has continued to receive increased attention for implementation at the industrial scale, one key remaining challenge is optimizing sorbent properties for climate-specific operating conditions. More specifically, as regions best suited for CO₂ capture operations (e.g., due to complementary infrastructures) are identified, the ability to tune sorbents such that they can perform efficiently at varying levels of temperature and humidity (e.g., regional and seasonal variations), for example, may be critical.

An additional key challenge is improving the working lifetime of the sorbents. More specifically, the aminopolymers that are responsible for the CO₂ capture mechanism undergo degradation upon exposure to atmosphere, which can be accelerated by the elevated temperatures typically required for sorbent regeneration (i.e., desorption of captured CO₂).

As such, development of modular aminopolymer frameworks, in which changes to the chemical structure can be used to tune key properties such as CO₂ binding strength, hydrophobicity, and mobility, is a critical step toward unlocking the full potential of this technology.

### SUMMARY

A product, in accordance with one aspect of the present invention, includes an aminopolymer having alkyl substituents coupled directly to carbon atoms in a backbone of the aminopolymer.

A method of forming an alkyl substituted aminopolymer, in accordance with one aspect of the present invention, includes polymerizing, via ring-opening polymerization, one or more types of heterocyclic monomers thereby creating a first polymer, the one or more types of heterocyclic monomers having at least one alkyl substituent coupled directly to a carbon atom of the associated monomer; and creating, from the first polymer, an alkyl substituted aminopolymer.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is a schematic drawing of a process using a conventional chemisorbent for CO₂ capture from ambient air (direct air capture).

FIG. 2 depicts basic structural repeat units for various types of aminopolymers having amine functionalities directly incorporated into the polymer backbone.

FIG. 3 is a depiction of illustrative repeat units for alkyl substituted polyethylenimines and polypropylenimines, in accordance with various embodiments.

FIG. 4 is a chart depicting results of density-functional theory (DFT) calculations demonstrating the effects of alkyl substitutions on dipropylamine, in accordance with various embodiments.

FIG. 5 is a flowchart of a method for forming an alkyl substituted aminopolymer, in accordance with various aspects of the present invention.

FIG. 6 depicts an illustrative method for production of a linear poly(ethylenimine) (PEI) with methyl substituents, in accordance with one approach.

FIG. 7 depicts an illustrative method for production of a chiral linear poly(ethylenimine) (PEI) with methyl substituents, in accordance with on approach.

FIG. 8 is a stepwise series of drawings depicting formation and use of a porous ceramic support with aminopolymer thereon for CO₂ capture, according to one embodiment. Part (a) represents the formation of a porous ceramic support. Part (b) represents incorporation of an aminopolymer to the porous ceramic support thereby forming a product. Part (c) represents capture of CO₂ from a mixed gas by the product. Part (d) represents regeneration performed on the product.

FIG. 9 is a depiction of a branched alkyl substituted aminopolymer, in accordance with an exemplary embodiment.

FIG. 10 is a depiction of a linear alkyl substituted aminopolymer, in accordance with an exemplary embodiment.

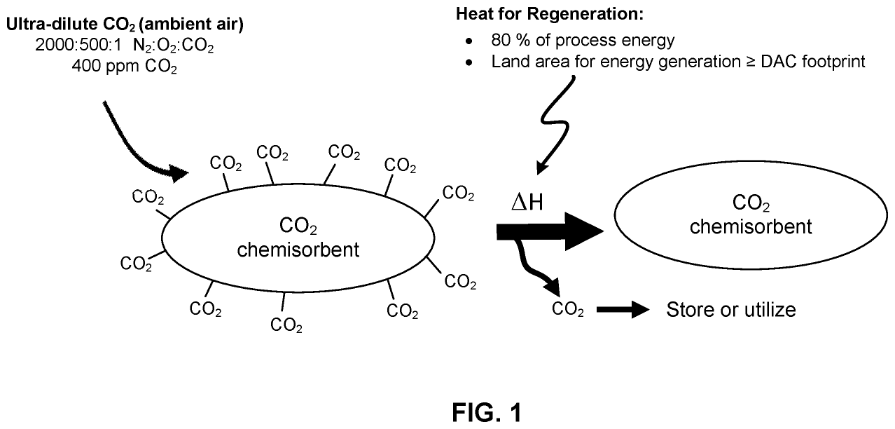

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

For the purposes of this application, room temperature is defined as in a range of about 20° C. to about 25° C.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm+1 nm, a temperature of about 50° C. refers to a temperature of 50° C.+5° C., etc.

It is also noted that, as used in the specification and the appended claims, wt. % is defined as the percentage of weight of a particular component is to the total weight/mass of the mixture. Vol. % is defined as the percentage of volume of a particular compound to the total volume of the mixture or compound. Mol. % is defined as the percentage of moles of a particular component to the total moles of the mixture or compound. Atomic % (at. %) is defined as a percentage of one type of atom relative to the total number of atoms of a compound.

Unless expressly defined otherwise herein, each component listed in a particular approach may be present in an effective amount. An effective amount of a component means that enough of the component is present to result in a discernable change in a target characteristic of a mixture, an ink, a printed structure, and/or final product in which the component is present, and preferably results in a change of the characteristic to within a desired range. One skilled in the art, now armed with the teachings herein, would be able to readily determine an effective amount of a particular component without having to resort to undue experimentation.

The following description discloses various embodiments of aminopolymers with alkyl backbone constituents and/or related systems and methods. Such aminopolymers are particularly useful as gas sorbents.

In one general embodiment, a product includes an aminopolymer having alkyl substituents coupled directly to carbon atoms in a backbone of the aminopolymer.

In another general embodiment, a method of forming an alkyl substituted aminopolymer includes polymerizing, via ring-opening polymerization, one or more types of heterocyclic monomers thereby creating a first polymer, the one or more types of heterocyclic monomers having at least one alkyl substituent coupled directly to a carbon atom of the associated monomer; and creating, from the first polymer, an alkyl substituted aminopolymer.

As mentioned above, solid-supported amine sorbents are one of the most promising classes of technology for CO₂ capture. The active material in these sorbents is an amine-dense polymer (aminopolymer), which is typically impregnated into a highly porous support to increase the aminopolymer surface area.

Various aspects of the present invention are directed to previously unknown aminopolymers having particular chemical structures selected to impart particular effects on properties such as CO₂ binding strength, mobility (e.g., as it relates to gas diffusivity), and hydrophilicity will be crucial in creating the next generation of CO₂ capture materials and systems.

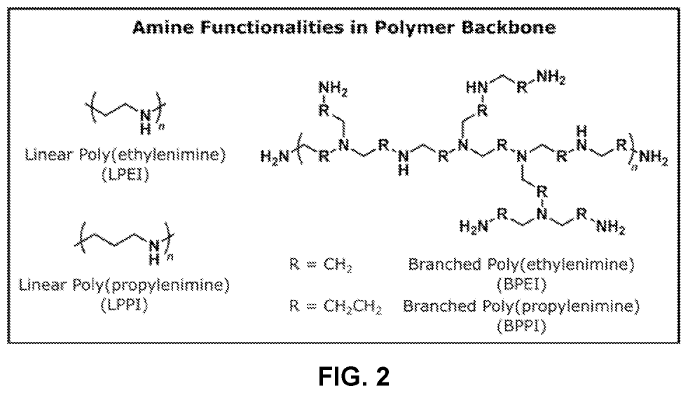

FIG. 2 depicts basic structural repeat units for various types of aminopolymers having amine functionalities directly incorporated into the polymer backbone. In the polymers shown, the amine functionalities in the polymer backbone are separated by two to three carbon atoms (poly(ethylenimine) (PEI) and poly(propylenimine) (PPI), respectively). These structures may be synthesized with either linear or branched structures, which impacts the physical properties (e.g. melting temperature, Tm, or glass transition temperature, Tg) as well as the ratio of amine functionalities (branched polymers may have mixtures of primary, secondary, and tertiary amines, while linear polymers have almost entirely secondary amines).

Various aspects of the present invention modify the aminopolymer structures such as those depicted in FIG. 2 by functionalizing the backbone with alkyl substituents. Seemingly small structural differences can have dramatic impacts on a polymer's physical properties, as observed in polyolefin crystallinities, for example.

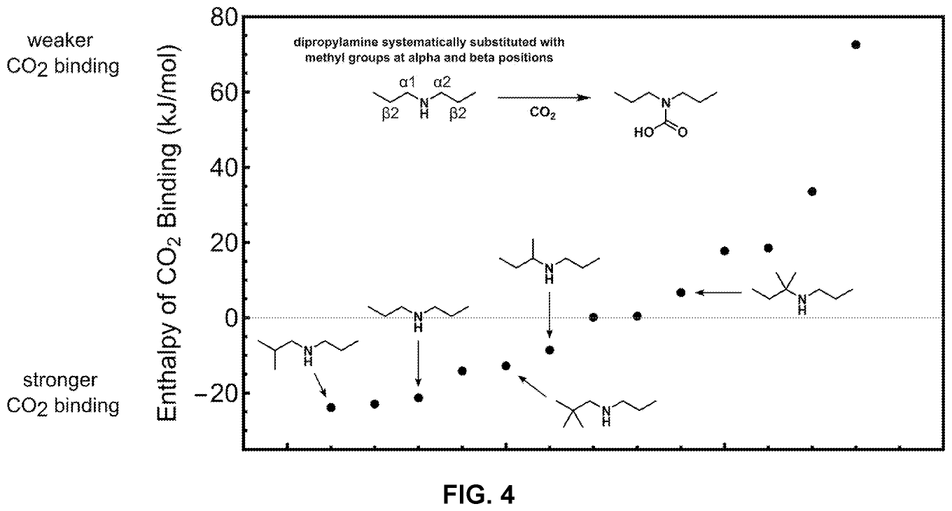

Additionally, in the context of aminopolymers for CO₂ capture, such structural changes can affect hydrophilicity and/or the CO₂ binding enthalpy due to altered steric environments around the nitrogens. The results of density-functional theory (DFT) calculations demonstrating the effects of alkyl substitutions on CO₂ binding enthalpy are shown in FIG. 4, which is discussed in more detail below.

In addition, selection of the location(s) and type(s) of alkyl substituents may impact the accessibility of the nitrogens to CO₂, affecting CO₂ capture rate and capacity. Control over such properties may play a crucial role in designing materials with lower energy requirements (e.g., for CO₂ desorption) and that are optimized for region-specific climates, both of which will in turn facilitate global deployment of CO₂ capture technology.

Functionalizing the backbone with alkyl substituents may also lead to increase in the stability of the polymer against oxidative degradation.

Preferred aspects of the present invention relate to structures and fabrication of alkylated linear poly(ethylenimine)s (LPEIs) and linear poly(propylenimine)s (LPPIs). These structures can be synthesized via chain growth polymerization such as conventional cationic ring opening polymerization (CROP), allowing for precise control over molecular weight.

A product, in accordance with one general approach, includes an aminopolymer having alkyl substituents coupled directly to carbon atoms in a backbone of the aminopolymer.

In some aspects, the aminopolymer is a linear polymer.

In other aspects, the aminopolymer is a branched polymer.

In preferred approaches, the alkyl substituted aminopolymer is selected from the group consisting of: poly(alkylamine), poly(ethylenimine), poly(propylenimine), poly(vinylamine), poly(allylamine), and a combination thereof. Particularly preferred aminopolymers are poly(ethylenimine) (PEI) and poly(propylenimine) (PPI) derivatives with one or more alkyl substituents coupled to at least one of the carbon atoms of the polymer backbone. Typically, the distal end groups of the aminopolymers are amine groups, but the end groups may be other things, e.g., alkyl groups, in some approaches.

The aminopolymer may have an average molecular weight in a range of about 350 grams per mol to about 100000 grams per mol, though some approaches may have higher or lower average molecular weights, e.g., in a range of about 1000 to about 50000 grams per mol. In preferred approaches, the aminopolymer has an average molecular weight of less than 10000 grams per mol.

The aminopolymer may comprise a plurality of repeat units that form the backbone. Any repeat unit or set of repeat units that would become apparent to one skilled in the art after reading the present disclosure may be present. Preferably, a majority of the repeat units have one or more of the alkyl substituents tethered thereto, i.e., coupled directly to a carbon atom or carbon atoms thereof. Note that in some approaches, the repeat units may all have the same basic backbone chain length. In other approaches, some of the repeat units have a different basic backbone chain length than other repeat units in the same molecule, e.g., some repeat units have two backbone carbons and some have three backbone carbons. Moreover, for branched polymers, the branches may have the same or different numbers of repeat units.

Co-polymers containing multiple types of repeat units, each containing zero, one, or more alkyl substituents, are also envisioned.

The alkyl substituents may be any alkyl group(s) that would become apparent to one skilled in the art after reading the present disclosure.

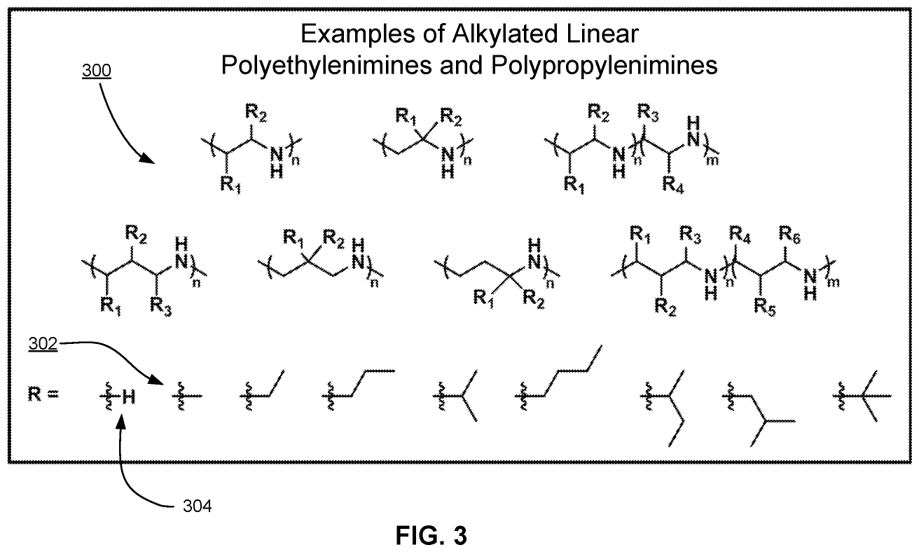

FIG. 3 depicts several illustrative repeat units 300 for poly(ethylenimines) and poly(propylenimines), as well as several illustrative alkyl substituents 302, and hydrogen 304.

In preferred approaches, the alkyl substituents and/or hydrogen, generally denoted in the group “R” in the drawing, may be tethered in any combination to the carbon atoms at R1-R6 of the repeat units, so long as some, and preferably a majority, of the repeat units in a given backbone have at least one alkyl substituent tethered thereto.

In preferred aspects, the alkyl substituents range from 1 carbon (methyl) to 4 carbon (butyl) alkyl chains, including all isomers for a given chain size (e.g. n-propyl and isopropyl for 3 carbon atom chains; n-butyl, sec-butyl, iso-butyl, and t-butyl for 4 carbon atom chains). Examples of such alkyl substituents 302 are shown in FIG. 3. Alkyl substituents having 5 or more carbon atoms are also contemplated, with a maximum carbon count of about 10.

One skilled in the art looking to create an aminopolymer with particular alkyl substituents tethered thereto may determine how to create an aminopolymer with the desired configuration by performing routine experimentation following the guidance presented herein.

Each repeat unit of the polymer may contain one or more alkyl substituents. As shown in FIG. 3, in some cases, at least some of the repeat units may have only a single alkyl substituent, e.g., such as where R1 is hydrogen and R2 is a methyl group in a repeat unit having an R1 and an R2. In other cases, at least some of the repeat units have at least two alkyl substituents, e.g., R1 and R2 are each, individually, alkyl substituents. For example, as shown in some examples in FIG. 3, at least two of the alkyl substituents are coupled to different carbon atoms of the associated repeat unit. In other approaches, at least two of the alkyl substituents are coupled to the same carbon atom of the associated repeat unit. In various aspects, the alkyl substituents of a single repeat unit may be of the same type, i.e., have the same chemical structure. In other approaches, none of the alkyl substituents coupled to the associated repeat unit are of a same type, i.e., none of the alkyl substituents on the particular repeat unit have the same chemical structure.

In some approaches, at least one alkyl substituent in each repeat unit is directly coupled to a carbon atom that is directly adjacent the amine in the repeat unit. Thus, for repeat units have a single alkyl substituent coupled thereto, the single alkyl substituent is, in some approaches, coupled to the carbon atom directly adjacent the amine. Likewise, where two alkyl substituents are coupled to the same carbon atom in the repeat unit, both alkyl substituents are coupled to a carbon atom directly adjacent the amine. Note, however, that alkyl substituent(s) may be tethered only to a carbon atom not directly adjacent to the amine by starting with a raw material that has the precursor group on the desired carbon, and proceeding according to the methodology presented herein.

In yet other approaches, at least some of the repeat units may have at least one different type of alkyl substituent coupled thereto relative to another of the repeat units immediately adjacent thereto. Said another way, one repeat unit may have one or more different alkyl substituents than the repeat unit immediately next to the repeat unit along the polymer backbone.

The average number of repeat units in the backbone of the aminopolymer may be in a range of 5 to about 1500. Referring to FIG. 3, the number of repeat units is denoted as “n.” In preferred approaches, the average number of repeat units is about 10 to about 50.

In some approaches, the product includes a structure supporting the aminopolymer. Preferably, the structure is three dimensional for increasing the surface area of the composite structure. For example, following synthesis of the aminopolymer with pendant alkyl substituents, the aminopolymer may be supported on a high-surface-area material of known type using known methods established in the literature. See, e.g., U.S. patent Ser. No. 11/446,634 and U.S. Pub. No. 2022-0401917-A1, which are herein incorporated by reference for their teaching of supporting a polymer on a three-dimensional structure.

The resulting polymer-support composite may then be used for any suitable purpose.

Exemplary uses include CO₂ capture and direct air capture. The capture and regeneration processes may follow conventional procedures currently used with conventional aminopolymers. Examples include steam stripping, temperature and/or vacuum swing desorption, and humidity swing desorption.

The invented materials described herein may be uniquely suited to increase the energy efficiency of a CO₂ adsorption-desorption process as well as sorbent longevity by tuning the enthalpy of CO₂ binding. More specifically, by decreasing the enthalpy of CO₂ binding (i.e., decreasing the strength of CO₂ binding) via steric interactions imposed by the introduced alkyl substituents, less energy (e.g., lower temperature) may be required to desorb the CO₂, which in turn may allow for improved sorbent lifetime, as aminopolymer evaporation and oxidation proceed faster at higher temperatures. Additionally, the introduced alkyl substituents may increase the mobility of some polymers by disrupting polymer crystallinity, which in turn may increase the CO₂ capture rate. Without wishing to be bound by any theory, it is currently believed that the presence of alkyl substituents in the alkyl substituted aminopolymer alters the intramolecular interactions of the polymer in the bulk phase, and therefore the mobility of those structures.

Thus, selection of particular alkyl substituents and the position thereof may enable one to simultaneously tune the polymer's binding strength and physical properties, which in turn may enable more efficient CO₂ capture processes and longer product lifetimes.

In addition, while not completely understood at this time, it appears that there is an important interplay between how much water is in a gas stream and how that concentration impacts both CO₂ uptake as well as stability. Without wishing to be bound by any theory, evidence is emerging that water in a gas stream improves CO₂ binding with amine-based sorbent materials, but the water also reduces stability of the materials.

At any given time, the gas stream pulled in for collection of CO₂ will have a certain percentage of water or humidity that can depend on a number of different factors such as the location, time of year, etc. The unsubstituted forms of aminopolymers are generally hydrophilic materials, and as such, various aspects of the present invention enable the ability to increase the hydrophobicity of the alkyl substituted aminopolymer, or in in other words decrease the likelihood of the material co-adsorbing water, by increasing the alkyl content. Thus, targeted placement of one or more particular isomers in certain spots may be used to tune the behavior of the molecule for a particular target application.

The results of density-functional theory (DFT) calculations demonstrating the effects that alkyl substitutions on dipropylamine have on CO₂ binding enthalpy are shown in FIG. 4, which is a chart depicting the results of modeling the effects on enthalpy of CO₂ binding with various alkyl groups at one or more of the alpha (α1, α2) and/or beta (β1, β2) positions of dipropylamine. Note that more negative enthalpy of CO₂ binding generally corresponds to stronger CO₂ bonding to the molecule.

The CO₂ binding enthalpies for various types of alkyl substituted aminopolymers are expected to follow a similar trend as that shown in FIG. 4 for similar combinations of alkyl substituents positioned at the alpha (α1, α2) and/or beta (β1, β2) positions.

As shown in FIG. 4, the CO₂ binding enthalpy tends to become more positive with addition of different alkyl groups. For example, the addition of one or two methyl groups at the al position have a fairly significantly altered CO₂ binding strength relative to the unsubstituted molecule. It is generally held to be disadvantageous to weaken the CO₂ binding for any CO₂ capture material. However, proceeding contrary to popular wisdom, alkyl substituted aminopolymers with relatively higher enthalpies of CO₂ binding may be useful in some circumstances such as in particular climate-specific CO₂ capture implementations, for example, such as for use in colder temperature environments.

Again, proceeding contrary to popular wisdom, one may be interested in materials that actually bind CO₂ more weakly, i.e., have more positive enthalpies, to enable lower energy cycling. The DAC process includes binding to the CO₂ and then releasing the CO₂ from the capture material, ideally in a in a pure form for storage, conversion to another form, etc. By lowering the binding strength, less energy is needed to release the CO₂ back off of the material. Thus, selection of a particular alkyl substituent or combination of alkyl substituents may be used to affect the amount of energy required to cycle.

Accordingly, materials according to various approaches may be uniquely suited for direct air carbon capture from cold-weather climates due to their lower CO₂ binding strength, allowing for more efficient CO₂ desorption/material regeneration at lower temperature with lower energy requirements.

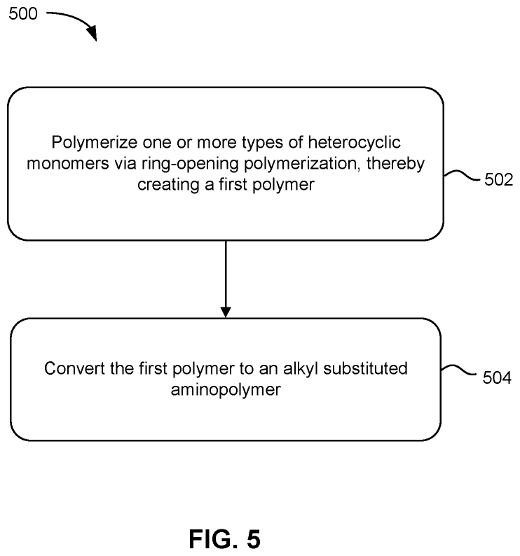

FIG. 5 shows a method 500 for forming an alkyl substituted aminopolymer, in accordance with various aspects of the present invention. As an option, the present method 500 may be implemented to form materials and structures such as those described elsewhere herein and/or shown in the other FIGS. Of course, however, this method 500 and others presented herein are presented by way of example only. Further, the methods presented herein may be carried out in any desired environment. Moreover, more or less operations than those shown in FIG. 5 may be included in method 500, according to various embodiments. It should also be noted that any of the aforementioned features may be used in any of the embodiments described in accordance with the various methods.

In step 502, one or more types of heterocyclic monomers are polymerized via ring-opening polymerization, thereby creating a first polymer. The one or more types of heterocyclic monomers have at least one alkyl substituent coupled directly to a carbon atom of the associated monomer. Exemplary heterocyclic monomers includes alkyl substituted oxazoline, alkyl substituted oxazine, alkyl substituted aziridine, alkyl substituted azetidine, etc. Such heterocyclic monomers may have any composition that would become apparent to one skilled in the art after reading the present disclosure.

In step 504, an alkyl substituted aminopolymer is created from the first polymer, e.g., using any technique described herein. The alkyl substituted aminopolymer may be branched or linear. In one approach, for oxazine/oxazoline derived polymers (linear) which have amide side chains, converting the first polymer to the alkyl substituted aminopolymer may include hydrolyzing the amide side chains. As noted above, a single monomer may be polymerized, or co-monomers may be polymerized together.

Any suitable heterocyclic monomer that would become apparent to one skilled in the art after reading the present disclosure may be used. Preferably, the monomer may have or be formed with the desired alkyl substituent(s) present in the desired location relative to the N atom. For example, commercially available precursors such as amino alcohols with the desired alkyl substituents with the alkyl group(s) appended thereto at the appropriate position(s) may be used.

In some approaches, the monomers are derived from ethanolamine or propanolamine type precursors, a wide variety of which are commercially available. The ethanolamine and/or propanolamine precursors may be converted into the corresponding heterocyclic molecule that can undergo polymerization into the desired base aminopolymer structure. In one preferred approach, the one or more types of heterocyclic monomers includes an alkyl substituted oxazoline. In another preferred approach, the one or more types of heterocyclic monomers includes an alkyl substituted oxazine.

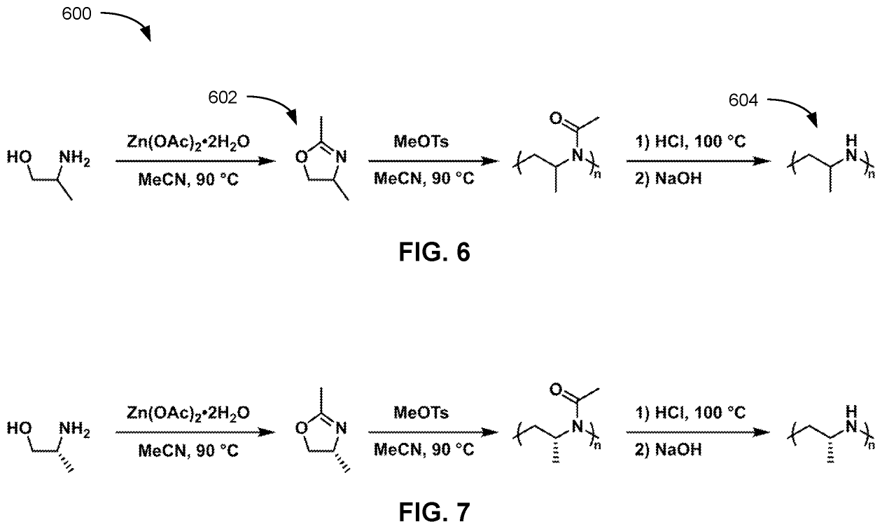

FIG. 6 depicts an illustrative method 600 for production of a linear PEI with methyl substituents, in accordance with one approach. As an option, the present method 600 may be implemented to form materials such as those described elsewhere herein and/or shown in other FIGS. Of course, however, this method 600 and others presented herein are presented by way of example only. Further, the methods presented herein may be carried out in any desired environment. Moreover, more or less operations than those shown in FIG. 6 may be included in method 600, according to various embodiments. It should also be noted that any of the aforementioned features may be used in any of the embodiments described in accordance with the various methods.

The illustrative method 600 for production of a linear PEI with methyl substituents uses a zinc catalyzed reaction of 2-aminopropan-1-ol and acetonitrile to generate 2,4-dimethyl-2-oxazoline. However, alternative alkyl groups at the 2 position may also be used. Additionally, alternative synthetic pathways may also be used.

The exemplary steps to obtain monomer 602 are conventional, and may generally follow the exemplary sequence shown in FIG. 6.

In an alternate approach, the monomer 602 may be purchased instead of synthesized.

The monomer 602 is polymerized via cationic ring-opening polymerization, via a conventional ring-opening polymerization procedure. In the example shown, the ring-opening step is performed using methyltoluene sulfonate (MeOTS) and MeCN.

Following polymerization, in the final step shown, the backbone amides are hydrolyzed under acidic conditions (e.g., in the presence of HCl), and the resulting material is then neutralized (e.g. via NaOH) to produce the final aminopolymer 604 with methyl substituents.

In exemplary approaches, alkyl substituted oxazoline and oxazine monomers may be synthesized, using known procedures, from 2-aminoethanol and 3-aminopropanol derivatives, respectively. The aminopolymers may then be synthesized via CROP of the alkyl substituted oxazoline and/or oxazine monomer. A known CROP procedure may be adapted for use, as would become apparent to one skilled in the art after reading the present disclosure. Following polymerization, the poly(oxazoline) and/or poly(oxazine) materials are converted into the alkyl substituted aminopolymer by hydrolyzing the side chains.

In further approaches, enantiopure isomers may be used for synthesis of chiral aminopolymers, as illustrated in FIG. 7. Enantiopure precursors are commercially available; accordingly, chiral aminopolymers may be formed according to the techniques described herein using such precursors.

Practical considerations to consider when selecting precursors for the monomer and/or aminopolymer, and in most cases thus the final structure of the alkyl substituted aminopolymer, include whether precursors that provide the desired alkyl substituents are commercially available or synthesizable for a reasonable cost, or convertible from another material.

Another consideration is the final overall ratio of carbon in the polymer relative to nitrogen. For example, as more or longer alkyl groups are added to the aminopolymer, the relative weight percent of the active component of the aminopolymer (e.g., amine) decreases.

Following synthesis of the alkyl substituted aminopolymer, the aminopolymer may be supported on a high-surface-area material using known methods, such as dipping and drying, deposition, spincoating, etc.

In one approach, adding the aminopolymer to the support may include immersing a three-dimensional (3D) porous structure, e.g., ceramic support, in a mixture of the aminopolymer suspended in a volatile hydrophilic solvent (e.g., methanol, ethanol, etc.), and then drying the structure to remove the solvent by evaporation. In some approaches, the evaporation of the solvent may include applying heat and/or vacuum. In another approach, the aminopolymer may be added to the support material by a chemical functionalization of chemically binding the aminopolymer to the support material. Following removal of the solvent, aminopolymer remains within the pores of the support material.

In preferred approaches, the loading of aminopolymer is in a range of 20 to 70 wt. % relative to the total weight of the polymer-support composite product.

Illustrative support materials include metal meshes, ceramic support materials, porous silicas, porous aluminas, hollow fibers, porous organics, metal-organic frameworks, and hierarchical alumina monoliths. etc.

This polymer-support composite can then be used for its intended purpose, such as CO₂ capture, direct air capture, etc.

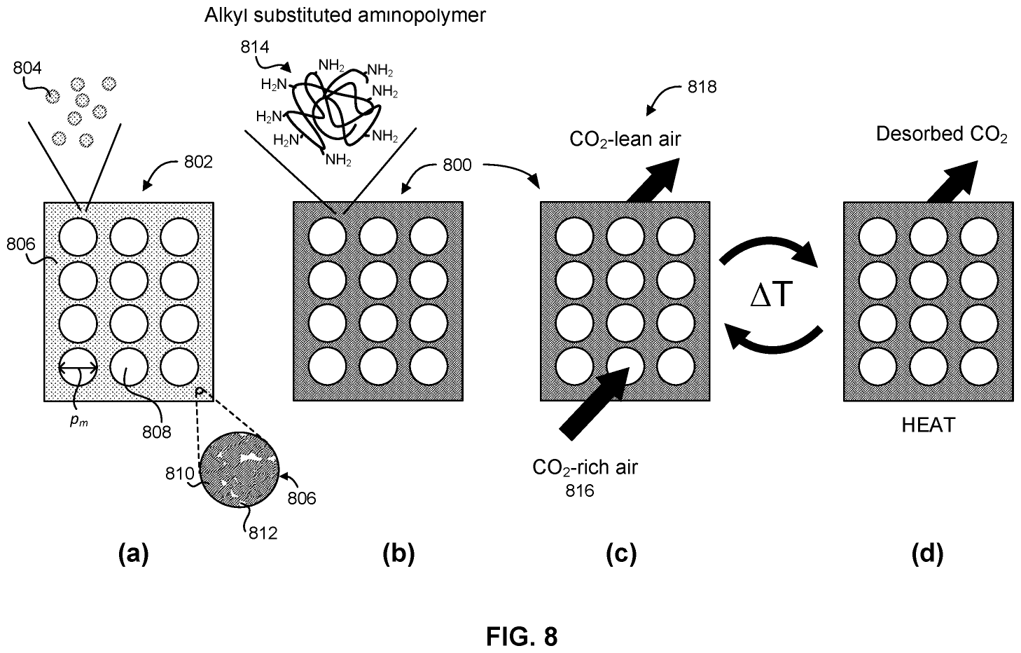

FIG. 8 illustrates, by way of example, a schematic diagram of the components of a product 800, in accordance with one embodiment. As an option, the present product 800 may be implemented in conjunction with features from any other inventive concept listed herein, such as those described with reference to the other FIGS. Of course, however, the product 800 and others presented herein may be used in various applications and/or in permutations which may or may not be specifically described in the illustrative embodiments listed herein. Further, the product 800 presented herein may be used in any desired environment.

As shown in part (a) of FIG. 8, the support is a 3D structure 802 constructed of any suitable material 806. In the example shown, the material 806 is ceramic. The 3D structure 802 may include features, inter-material pores 808 (where the pore is formed from a shape of the material), voids for the flow of the mixed gas stream through the porous product 800. In one approach the 3D structure 802 may be a monolithic form for low gas flow pressure drop.

Looking to the magnified view of a portion of ceramic material 806, the ceramic material 806 includes partially sintered ceramic particles 810 and an open cell structure with a plurality of intra-material pores 812. The open cell structure of the material may be defined as having interconnected pores, the pores are not sealed, the void space created within the pores allows the flow of gas, liquid, etc. to pass through the material, etc. The ceramic material 806 may be a mesoporous material having intra-material pores 812 with an average diameter in a range of about greater than 1 nanometer (nm) to about 50 nm. In some approaches, the intra-material pores 812 of the ceramic material 806 may be in a range of greater than 1 nm to less than 10 μm. In one approach, the intra-material pores 812 of the ceramic material 806 may be in a range of greater than 1 nm to about 1000 nm.

The ceramic material 806 of the 3D structure 802 may be formed from a powder 804 of ceramic material. The 3D structure 802, e.g., support structure, may be comprised of one or more of a variety of ceramic materials, including a metal oxide, a metalloid oxide, a metal carbide, a metalloid carbide, or a combination thereof. For example, in some approaches, the ceramic material may include SiO₂, Al₂O₃, TiO₂, MgO, SiC, etc.

The ceramic support may be synthesized via a variety of techniques utilizing preceramic polymers, ceramic powders, etc. including partial sintering, replica or sacrificial templating, direct foaming, bonding, aerogel formation, freeze-casting, or others. Additive manufacturing approaches including but not limited to direct ink writing, powder bed fusion, jetting, extrusion, or deposition may be used in the synthesis of the support material.

According to one embodiment, the 3D structure, e.g., bulk structure, includes a ceramic material comprising connections between particles thereby forming a porous material. The material of the ceramic support structure is porous, with multiple possible scales of hierarchical porosity. The material may have intra-material pores creating a small-scale, microporosity, or mesoporosity of intra-material pores having an average diameter in the range of greater than 1 to 1000 nanometers (nm) and/or a macroporosity of intra-material macropores having an average diameter in a range of greater than or equal to 10 micron (μm). In some approaches a material may have a number of length scales or pores, e.g., microporosity and mesoporosity, mesoporosity and microporosity, etc., all of which may be considered as intra-material pores. Moreover, in some approaches, a bulk structure may have feature sizes, inter-material pores 808, voids, etc. having an average diameter pₘ in a range of 100 μm to 1 millimeters (mm).

In one approach, the support material may be of monolithic form designed for optimal gas flow and low gas flow pressure drop. In other approaches, the support material may be a 3D structure with pre-defined geometry designed for optimal gas flow. In some approaches, the support material may be a 3D structure formed by methods such as use of a template, a mold, a cast, etc. The pores of the support material, e.g., intra-material pores, may be formed in part with a pore-forming agent, a binder, etc. as described herein.

In preferred approaches, the porosity of the 3D structure may be in a range of about 30% to 70%. In one approach, a specific surface area of the 3D structure may be in the range of 1 to 500 m²/g (meter squared per gram) and may be higher.

As illustrated in part (b) of FIG. 8, the 3D structure 802 of ceramic material 806 may be loaded, incorporated, etc. with one or more polyamines, as described herein, as gas sorbent additive(s). In one approach, the product 800 includes polyamine 814 primarily present in the intra-material pores 812 of the ceramic material 806 for sorption of a specific gas. In some approaches, the amount of amine-containing sorbent additive may be present in a range of greater than 20 wt. % to less than 70 wt. % of the combined weight of the aminopolymer and the ceramic material.

Part (c) illustrates how the product (support+aminopolymer) is contacted with a gas stream rich in a gas of interest to be selectively removed. For example, in one approach, an air stream that includes several gases and CO₂, e.g., a CO₂-rich air 816, may flow through the product 800. The sorbent selectively adsorbs some or all of the CO₂ gas from the gas stream, e.g., CO₂ from ambient air in DAC. The air stream now depleted substantially of CO₂, e.g., CO₂-lean air 818, continues to flow out of the 3D structure 802. Typically, the CO₂-lean air has a reduced CO₂ content compared to the incoming CO₂-rich air.

As shown in part (d), the incoming gas stream may be switched off, and the sorbent material may be regenerated by a process involving increased temperature, e.g., by application of a hot gas such as steam, joule heating, etc. In one approach, the heating may include application of a vacuum, e.g., temperature vacuum swing adsorption.

Once the sorbent ceramic product is regenerated and adsorbed gas removed from the system, the cycle may repeat, (as shown in part (c)), in which the sorbent additive is exposed to a mixed gas stream for adsorption of a selected gas. In some approaches of the cyclic adsorption-regeneration process, the adsorbed gas may not be completely removed from the sorbent during regeneration. For example only, the cycling CO₂ loading range may be selected to maximize long-term performance and throughput, and often the process may involve incomplete removal of the adsorbed CO₂.

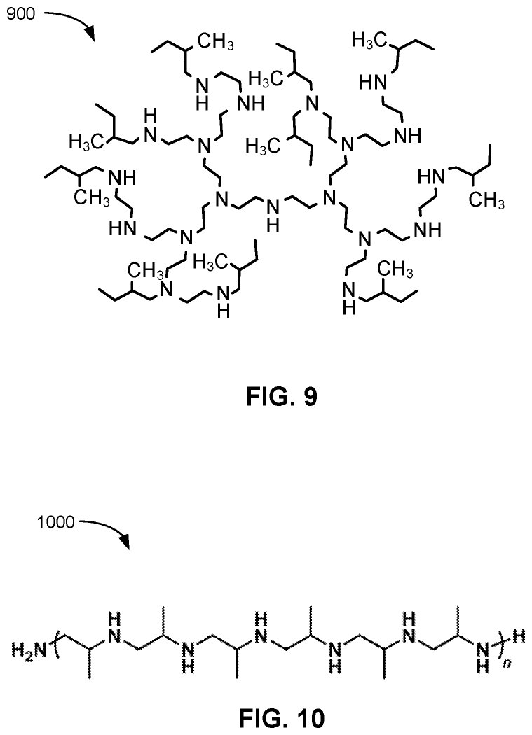

An illustrative branched alkyl substituted aminopolymer 900 is depicted in FIG. 9.

An illustrative linear alkyl substituted aminopolymer 1000 is depicted in FIG. 10.

In Use:

Exemplary uses of the materials presented herein include: CO₂ capture from dilute sources such as atmosphere or more concentrated sources such as flue gas; CO₂ scrubbing from confined spaces (e.g. building, office, spacecraft, etc.); etc.

Other potential uses of the alkyl substituted aminopolymers described herein may include use in adhesives, detergents, drug delivery, and other areas of biotechnology.

While various aspects of an inventive concept have been described above, it should be understood that they have been presented by way of example only, and not limitation. Thus, the breadth and scope of an aspect of an inventive concept of the present invention should not be limited by any of the above-described exemplary aspects of an inventive concept but should be defined only in accordance with the following claims and their equivalents.

1. A product, comprising:
an aminopolymer having alkyl substituents coupled directly to carbon atoms in a backbone of the aminopolymer.

2. The product as recited in claim 1, wherein the aminopolymer is a linear polymer.

3. The product as recited in claim 1, wherein the aminopolymer is a branched polymer.

4. The product as recited in claim 1, wherein the aminopolymer is a polyethylenimine.

5. The product as recited in claim 1, wherein the aminopolymer is a polypropylenimine.

6. The product as recited in claim 1, wherein the aminopolymer comprises a plurality of repeat units that form the backbone, wherein at least some of the repeat units have one or more of the alkyl substituents coupled directly to a carbon atom thereof.

7. The product as recited in claim 6, wherein at least some of the repeat units have a single alkyl substituent.

8. The product as recited in claim 6, wherein at least some of the repeat units have at least two alkyl substituents.

9. The product as recited in claim 8, wherein at least two of the alkyl substituents are coupled to different carbon atoms of the associated repeat unit.

10. The product as recited in claim 8, wherein at least two of the alkyl substituents are coupled to the same carbon atom of the associated repeat unit.

11. The product as recited in claim 8, wherein none of the alkyl substituents coupled to the associated repeat unit are of a same type.

12. The product as recited in claim 8, wherein at least two of the alkyl substituents coupled to the associated repeat unit are of a same type.

13. The product as recited in claim 6, wherein at least some of the repeat units have at least one different type of alkyl substituent coupled thereto relative to another of the repeat units immediately adjacent thereto.

14. The product as recited in claim 6, wherein a total number of repeat units in the backbone is in a range of 5 to about 1500.

15. The product as recited in claim 1, wherein the alkyl substituents are selected from the group consisting of:

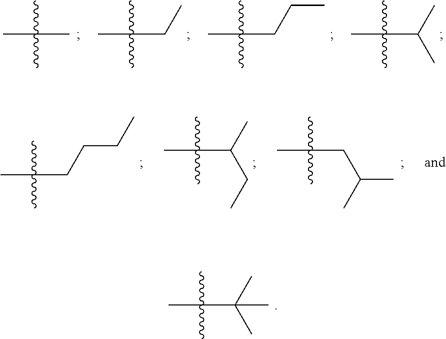

16. The product as recited in claim 1, comprising a three-dimensional structure supporting the aminopolymer.

17. The product as recited in claim 1, wherein the aminopolymer is selected from the group consisting of: poly(alkylamine), poly(vinylamine), poly(allylamine), and a combination thereof.

18. The product as recited in claim 1, wherein the aminopolymer has an average molecular weight in a range of about 350 to about 100000 grams per mol.

19. A method of forming an alkyl substituted aminopolymer, the method comprising:
polymerizing, via ring-opening polymerization, one or more types of heterocyclic monomers thereby creating a first polymer, the one or more types of heterocyclic monomers having at least one alkyl substituent coupled directly to a carbon atom of the associated monomer; and
creating, from the first polymer, an alkyl substituted aminopolymer.

20. The method as recited in claim 19, wherein the one or more types of heterocyclic monomers includes an alkyl substituted oxazoline.

21. The method as recited in claim 19, wherein the one or more types of heterocyclic monomers includes an alkyl substituted oxazine.

22. The method as recited in claim 19, wherein the one or more types of heterocyclic monomers includes an alkyl substituted aziridine.

23. The method as recited in claim 19, wherein the one or more types of heterocyclic monomers includes an alkyl substituted azetidine.

24. The method as recited in claim 19, wherein the first polymer has amide side chains, and wherein creating the alkyl substituted aminopolymer further comprises hydrolyzing the amide side chains.

25. The method as recited in claim 19, wherein the alkyl substituted aminopolymer is a branched polymer.
